(19) United States
(12) Patent Application Publication
(10) Pub. No.: US 2012/0256333 A1
(43) Pub. Date: Oct. 11, 2012

(54) PROCESS FOR MANUFACTURING A STAND-ALONE MULTILAYER THIN FILM

(75) Inventors: Ayse Hancer-Ademuwagun, Ypsilanti, MI (US); Songtao Wu, Ann Arbor, MI (US); Debasish Banerjee, Ann Arbor, MI (US); Minjuan Zhang, Ann Arbor, MI (US); Masahiko Ishii, Okazaki City (JP)

(73) Assignees: Toyota Motor Corporation, Toyota (JP); Toyota Motor Engineering & Manufacturing North America, Inc., Erlanger, KY (US)

(21) Appl. No.: 13/527,996

(22) Filed: Jun. 20, 2012

Related U.S. Application Data
(63) Continuation-in-part of application No. 12/974,325, filed on Dec. 21, 2010.

(51) Int. Cl. B29C 41/00; B29D 11/00

(52) U.S. Cl. 264/1.9; 264/241; 264/1.7

(57) ABSTRACT

A process for manufacturing stand-alone multilayer thin films is provided. The process includes providing a substrate, depositing a sacrificial layer onto the substrate and the depositing multilayer thin film onto the sacrificial layer. Thereafter, the substrate, sacrificial layer and thin film structure are exposed to chemical solutions. The chemical solution selectively reacts with the sacrificial layer to remove the sacrificial layer, thereby affording for an intact multilayer stand-alone thin film to separate from the substrate. The color and optical properties of the multilayer thin film are not affected by the removal of the sacrificial layer.

### CROSS REFERENCE TO RELATED APPLICATIONS

This application is a continuation-in-part of U.S. patent application Ser. No. 12/974,325 filed on Dec. 21, 2010, which is incorporated herein in it entirety by reference.

### FIELD OF THE INVENTION

The present invention is related to a process for manufacturing a multilayer thin film, and in particular, to a process for manufacturing a stand-alone multilayer thin film which retains the optical and color properties of the film.

### BACKGROUND OF THE INVENTION

The production of multilayer thin films on substrates is well known. For example, multilayer thin films produced on metals, semiconductors, oxides, and the like for protection of an underlying substrate, enhancement of surface properties for a component, aesthetic purposes, etc., are known. However, processes for producing multilayer thin films that are not attached to a substrate, that is stand-alone multilayer thin films, are not well known. In addition, known processes for producing such multilayer thin films require corrosive processes which disturb the optical and color properties of the multilayer thin films. Therefore, a process that allows for the manufacture of stand-alone multilayer thin films would be desirable.

### SUMMARY OF THE INVENTION

A process for manufacturing stand-alone multilayer thin films is provided. The process includes providing a substrate, depositing a sacrificial layer onto the substrate and then depositing a multilayer thin film onto the sacrificial layer. Thereafter, the sacrificial layer is selectively removed by exposure to a chemical solution. In particular, the chemical solution reacts with and thereby removes the sacrificial layer, affording an intact stand-alone multilayer thin film separate from the substrate.

In some instances, the substrate can be glass. The substrate can be planar or non planar. In addition, the sacrificial layer can be a polymer layer, a metallic layer, and the like, which can be deposited using a vacuum deposition technique, a sol-gel technique and/or a layer-by-layer technique.

The chemical solution can be an alkaline etchant, such as sodium hydroxide or potassium hydroxide, an acid etchant or a solvent, which dissolves the sacrificial layer, thereby separating the multilayer thin film from the substrate. In addition, the thin, film can have a multilayer structure, e.g., a multilayer stack that provides an omnidirectional structural color, an omnidirectional infrared reflector, and/or an omnidirectional ultraviolet reflector.

### BRIEF DESCRIPTION OF THE DRAWINGS

FIG. 1 is a schematic diagram of a process according to an embodiment of the present invention;

FIG. 2 is a schematic illustration of the manufacture of a stand-alone multilayer thin film produced according to an embodiment of the present invention;

FIGS. 3-5 are scanning electron microscopy (SEM) images and energy dispersive spectroscopy (EDS) elemental mappings of flakes at high (20 kV) and low (11 kV) voltage, illustrating that the sacrificial layer was completely removed and a multilayer thin film, along with its optical and color properties, were preserved.

### DETAILED DESCRIPTION OF THE INVENTION

The present invention discloses a process for manufacturing a stand-alone multilayer thin film. Such stand-alone multilayer thin films can be subjected to crushing, grinding, and/or sieving in order to produce particles in the form of flakes, the flakes being used as a pigment. Therefore, the present invention has utility for the production of flakes and/or pigments.

The process includes depositing a sacrificial layer onto a substrate followed, by depositing a multilayer thin film onto the sacrificial layer. Thereafter, the substrate with the sacrificial layer deposited thereon and the multilayer thin film deposited onto the sacrificial layer are exposed to a chemical solution which is either an alkaline etchant, an acid etchant or a solvent. The exposure of the substrate, sacrificial layer and multilayer thin film to the alkaline etching, acid etchant or solvent affords for dissolution of the sacrificial layer, thereby separating the multilayer thin film from the sacrificial layer.

It is appreciated that removal of the sacrificial layer results in a “stand-alone” multilayer thin film, i.e. a multilayer thin film that has been removed from the substrate and is free-standing—independent and/or unattached from the substrate. In addition, the thin film can be intact, that is, present in its as-deposited form and generally not present as broken and/or crushed-up particles and the like.

The substrate can be any material known to those skilled in the art, such as glass, silicon, wafer, polymer, etc. As such, the substrate is generally inert to the alkaline etchant, acid etchant or solvent, however this is not required. For example and for illustrative purposes, the substrate can be glass, which does not degrade when exposed to the alkaline etchant solvent. In addition, the substrate can be planar or non-planar, e.g. in the form of a coil.

The sacrificial layer can be made from metallic and/or semiconductor materials such as aluminum, aluminum gallium arsenide, aluminum trioxide/alumina/sapphire, antimony, bismuth, brass, bronze, carbon, chromium, cobalt, copper, gallium arsenide, germanium, hafnium, indium, indium gallium arsenide, indium gallium phosphide, indium phosphide, indium phosphide oxide etchants, iridium, iron, lead, magnesium, molybdenum, nickel, niobium, tin, titanium, tungsten, vanadium, zinc, alloys thereof and the like.

For example and for illustrative purposes only, the sacrificial layer can be an aluminum layer deposited using a vacuum deposition technique. The alkaline etchant can be any base that selectively reacts with the metallic and/or semiconductor sacrificial layer so as to selectively detach the substrate from the multilayer thin film without disturbing the optical and/or color properties of the multilayer thin film. For example and illustrative purposes only, the alkaline etchant can be sodium hydroxide, which selectively reacts with a sacrificial aluminum layer, thereby separating the substrate from the multilayer thin film.

In the alternative, a sacrificial layer can be made from a polymeric material as shown in the left-hand column of Table 1 with the right-hand column providing a list of possible solutions or solvents for dissolution of the material. If the sacrificial layer is a polymer layer, the polymer layer can be deposited onto the substrate using a sol-gel technique and/or a layer-by-layer technique.

TABLE 1

| Polymer | Solvent |
|---|---|
| acenaphthylene/MMA | THF, DMF |
| acenaphthylene/Styrene/acrylic | THF, DMF |
| acrylic/butadiene/styrene | THF, DMF |
| ABS | DMF, DMSO, THF |
| (acrylonitrile/butadiene/styrene) | |
| amides | DMF |
| acrylimide/acrylic acid | H2O + Na AC + KH2PO4, DMSO |
| acetylene (Low Molecular | TCB, Toluene |
| Weight) | |
| acrylics | Toluene, THF, DMF, DMSO |
| acrylonitrile/butadiene Rubber | Toluene, DMF, TCB |
| Alkyd Resins | Toluene, THF, chloroform, DMAC |
| alkyl Resins | THF, chloroform |
| alkyene glycols | ODCB, Toluene, THF, chloroform |
| amide/imide | DMF, DMAC, DMSO, DMF + LiBR |
| acrylonitrile | DMF |
| acrylic acids | H2O + .05M NH4Ac + 2% MEOH |
| | Ph. @ 7.2w/NH4OH |
| Amylose proprionate | THF |
| Amylose Acetate | THF |
| Amylose Butyrate | THF |
| Acrylonitrile/Styrene | THF |
| butene-1 | ODCB, Toluene, TCB |
| Butyl Rubber | ODCB, Toluene, TCB |
| butyl Methacrylate | DMF |
| butylene terephalate | m-cresol |
| butadiene/acrylic | Toluene, DMF |
| acid/acrylonitrile | |
| butyl isocyanate | THF |
| Cellulose acetate | THF, DMF |
| Cellulose nitrate | THF |
| Chlorinated polyethylene | TCB |
| (Chloroprene) | |
| caprolactam | m-cresol, HFIP |
| carbonates | ODCB, THF, TCB |
| Carboxylated polybutadiene | THF |
| Carboxy Methyl Cellulose | H2O, DMF |
| Cis-isoprene | THF |
| Cellulose trinitrate | THF |
| Dextrans | H2O, DMSO |
| dialkyl phthalate | ODCB, Toluene, chloroform, TCB |
| dimethylsiloxanes | ODCB, Toluene, TCB, chloroform |
| dodecylacrylate | THF |
| dioxalane | THF |
| ethylene oxide | THF, DMF, H2O, TCB |
| ethers | Toluene, THF, DMF |
| epichlorohydran | TCB |
| Epoxy Resins | Toluene, THF, chloroform |
| ethyl acrylates | ODCB, Toluene, DMF, m-cresol |
| ethylene/vinyl acetate (EVA) | TCB |
| ethylene/propylene | ODCB, TCB |
| ethylene terephthalate (PET) | m-cresol, HFIP |
| ethylene/acrylic acid (NA + form) | TCB |
| ethylene/methylacrylate | TCB |
| ethylene/hexane-1 | TCB |
| esters | m-cresol, HFIP, TCB, Toluene |
| Fatty Acids | ODCB, THF, chloroform, TCB |
| Furfurylalcohol | ODCB, THF, chloroform, TCB |
| Gelatins | H2O, DMSO |
| glycerides | ODCB, THF, TCB |
| glycol/glycerine polyesters | DMF, DMF + 0.005% LiBR |
| glycols | ODCB, Toluene, THF, DMF, TCB |
| isoprene | Toluene, TCB |
| isobutylene | Toluene, THF |
| isocyanates | Toluene, THF, DMF, chloroform |
| imides | DMAC, DMF |
| imic acid | NMP |
| Isopropylidene-1,4-Phenylene | THF |
| Lignin sulfonates | H2O |
| Lipids | methylene chloride, THF |
| Melamines | HFIP, m-cresol, TFA, TCB |
| methyl methacrylate | Toluene, THF, DMF, m-cresol, |
| | DMAC |
| methyacrylates | TCB, DMF, THF |
| methyl methacrylate/styrene | ODCB, Toluene, THF, chloroform |
| methyl Pentene | TCB |
| oxycarbonyloxy-1,4-Phenylene | THF |
| oxypropylene | THF |
| oxymethylene | DMAC |
| octadecyl methacrylate | DMF, DMSO at 140° C. |
| octadecylvinylether | THF |
| oxymaleoyloxhexamethylene | THF |
| oxysuccinyloxhexamethylene | THF |
| Polyols | THF, DMF |
| Phenolic novalacs | THF, Choloform |
| Phenol formaldehyde Resins | THF, TCB |
| phenylene oxide | TCB |
| propylene | ODCB, TCB |
| propylene oxide | THF, TCB |
| propylene/butene-1 | ODCB, TCB |
| vinyl acetate | ODCB, THF, DMF |
| vinyl alcohol | H2O, DMF, DMSO |
| vinyl butyral | THF, DMF |
| vinyl chloride | Toluene, THF |
| vinyl floride | DMF |
| vinyl methyl ethers | THF, DMF |
| vinyl chloride/vinyl | DMF |
| acetate/maleic acid | |
| vinyl alcohol/vinyl acetate | DMF, DMSO |
| vinyl esters | DMF, THF |
| vinyl pyrrolidone/vinyl acetate | DMF |
| vinyl acetate/ethylene | DMF |
| vinyl acetate/ethylene/acrylate | DMF |
| vinyl bromide | THF |
| vinyl ferrocene | THF |
| vinyl carbazol | THF |
| vinyl formal | THF |
| Cellulosic propionates | Alcohols and Ketones |

The multilayer thin film can be deposited onto the sacrificial layer using any method or process known to those skilled in the art such as a vacuum deposition process, a sol-gel process, and/or a layer-by-layer process. The multilayer thin film can have two or more layers. For example and for illustrative purposes only, the thin film can have a multilayer structure in the form of an omnidirectional structural color, an omnidirectional infrared reflector, and/or an omnidirectional ultraviolet reflector. Omnidirectional structural colors, omnidirectional infrared reflectors, and/or omnidirectional ultraviolet reflectors such as those disclosed, in commonly assigned U.S. patent application Ser. Nos. 11/837,529; 12/388,395; and 12/389,221 can be the type of thin film deposited onto the sacrificial layer.

The removal of the sacrificial layer using a chemical solution to produce a free standing thin film does not affect the color or optical properties of the multilayer thin film. For example, the visual color, absorbing properties, reflecting properties, etc., of the multilayer thin film are the same and/or equivalent as they were prior to removal of the sacrificial layer.

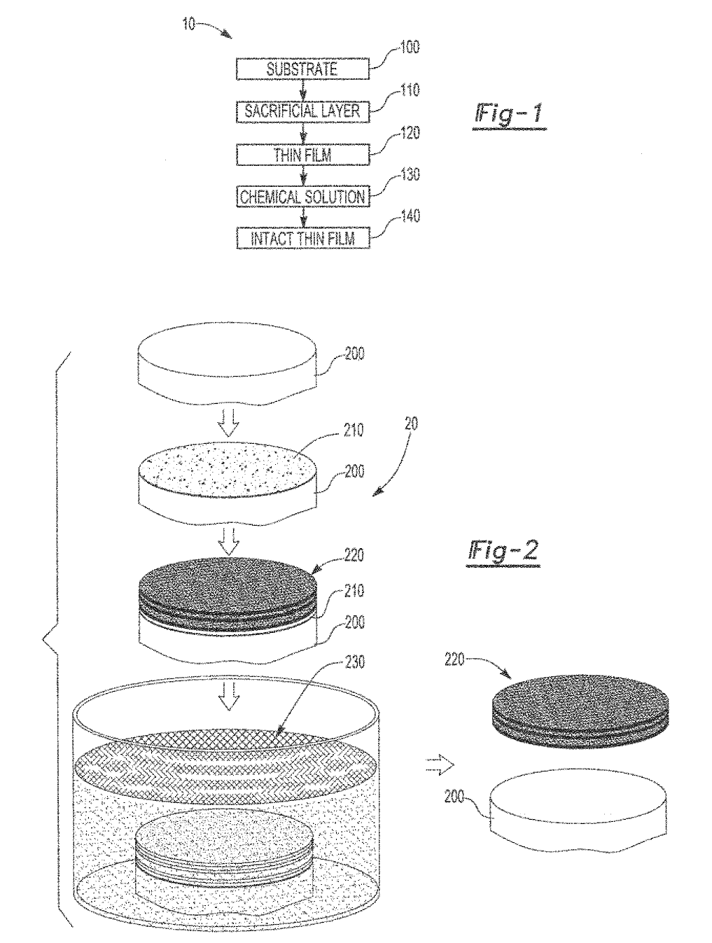

Turning now to FIG. 1, a schematic diagram illustrating a process to an embodiment of the present invention is shown generally at reference numeral 10. The process 10 includes providing a substrate at step 100 and depositing a sacrificial layer onto the substrate at step 110. A multilayer thin film is deposited onto the sacrificial layer at step 120 and the substrate, sacrificial layer and multilayer thin film structure are exposed to a chemical solution at step 130. As stated above, contact between the sacrificial layer and the chemical solution results in a chemical reaction to afford for the removal of the sacrificial layer from between the substrate and the multilayer thin film. It is appreciated that removal of the sacrificial layer affords for the multilayer thin film to be removed and/or separated front the substrate. The multilayer thin film can be intact and stand-alone. The optical and color properties of the multilayer thin film are not affected by the alkaline etching.

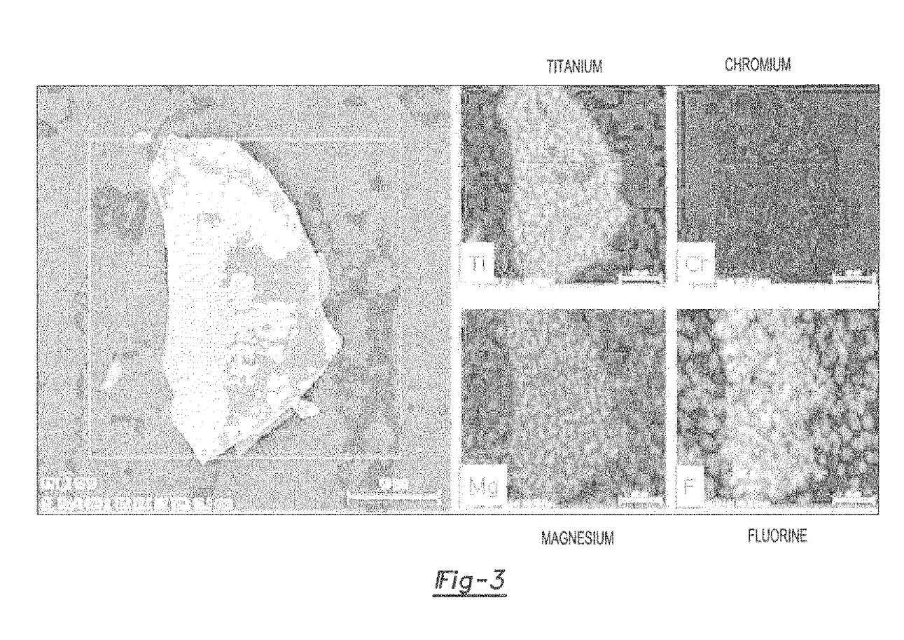

Turning now to FIG. 2, a schematic illustration of the manufacture of a stand-alone multilayer thin film is shown generally at reference 20. The process 20 includes providing a substrate 200 and depositing a sacrificial layer 210 onto the substrate 200. Thereafter, a multilayer thin film 220 is deposited onto the sacrificial layer 210. The substrate 200, sacrificial layer 210 and multilayer thin film 220 are then exposed to a chemical solution 130, which reacts with the sacrificial layer 210 to remove the sacrificial layer. Removal of the sacrificial layer 210 thus results in the multilayer thin film 220 being removed from the substrate 200. The multilayer thin film 220 can be intact and in this manner a stand-alone multilayer thin film is provided.

It is appreciated that the multilayer thin film 220 can be sectioned while still attached to the sacrificial layer 210. For example and for illustrative purposes only, a knife such as a diamond-tipped knife can be used to section the multilayer to film 220 before exposure to the chemical solution with a plurality of stand-alone thin films provided by the process disclosed herein.

In order to better illustrate and teach the present, invention, and yet not limit the scope in any ray, illustrative example is provided.

### EXAMPLES

### Base Solution Etching

Multilayer structural colored thin films having major components of titania (TiO₂), magnesium fluoride (MgF₂), and chromium (Cr) were deposited onto a glass substrate that had an aluminum sacrificial layer thereon. Stated differently, an aluminum layer was deposited onto the glass substrate and was present at the interface between the glass substrate and the multilayer structural colored film. Thereafter, the multilayer structural colored films were sectioned into small rectangular pieces by scribing of the film with a diamond knife. The glass substrate with the sacrificial layer and multilayer structural colored film was then soaked in a solution of 1M sodium hydroxide (NaOH). The solution with the glass substrate, sacrificial layer and multilayer structural colored film was heated to 60° C. in a hot water bath for 2 hours and then allowed to cool.

After cooling, intact sections of the multilayer structural colored film were found to be detached from the substrate. The yield of the process was approximately 100%. The sections of the stand-alone multilayer structural colored films were then subjected to crushing, grinding, and sieving in order to produce flakes of desired size exhibiting an omnidirectional structural color.

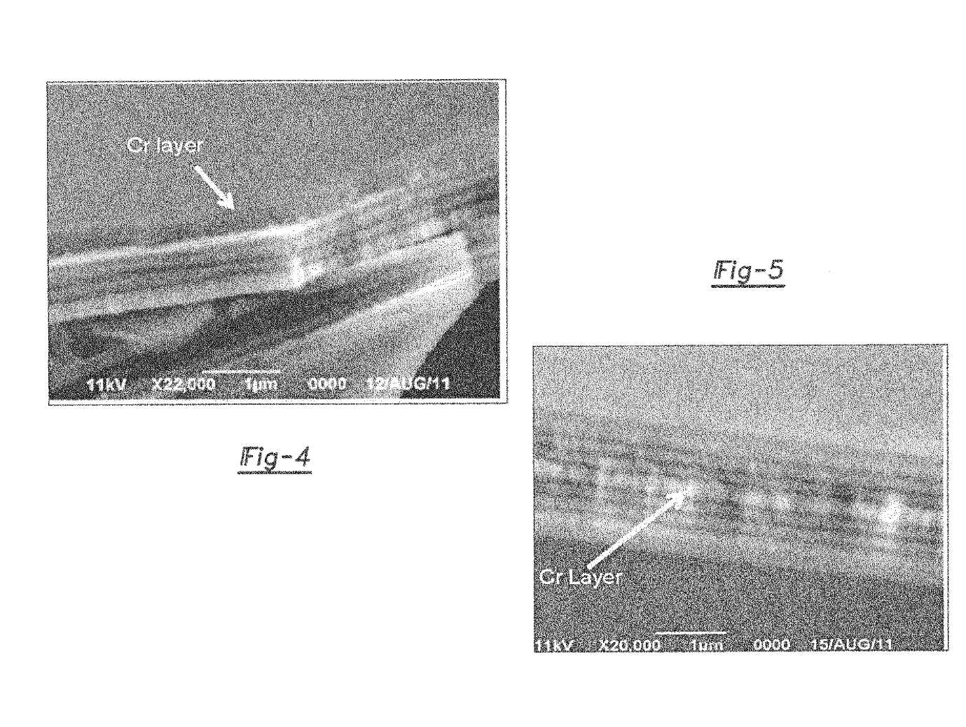

Flakes of the omnidirectional structural color thin films were then subjected to scanning electron microscopy (SEM) and energy dispersive spectroscopy (EDS) elemental analysis. An SEM image is shown on the left-hand side of FIG. 3 and automatic EDS mapping results at a high accelerating voltage (20 kV) are shown on the right-hand side of the figure. At such a high voltage the interaction volume could be larger than the thickness of the thin film (˜1 μm) thus the information of all the elements in the flakes could be obtained. As shown in the EDS mapping, five elements have been automatically identified, titanium (Ti), chromium, (Cr), magnesium (Mg), fluorine (F), Oxygen (O) (not shown in the figure). Neither silicon (Si) nor aluminum (Al) was found in the mapping and optical analysis of the flakes illustrated that color and optical properties of the multilayer thin film were also preserved with no damage. Hence, it is appreciated that all of the elemental compositions contributing to the essential optical properties of the thin film were preserved.

### Acid Solution Etching

An acid etching method was developed using aqua regia solution. Concentrated nitric acid (HNO₃) and concentrated hydrochloric acid (HCl) (1:3 ratio) was mixed and multilayer structural colored thin films were reacted at room temperature to remove sacrificial Al layers. It is appreciated that the high concentration of chloride ions in aqua regia affords for a generally rapid reaction with the Al layer and thus oxidation of more Al to Al⁺³. The aluminum can also react directly with the free chlorine in aqua regia, since chlorine is a powerful oxidizing agent.

Two major parameters were tested: (1) ratio of concentrated nitric acid to concentrated hydrochloric acid; and (2) reaction time. In addition, eight layer stacks having alternating layers of SiO₂ and TiO₂, on both sides of a middle Cr layer, were produced for the acid etching testing.

FIG. 4 provides an SEM image for a SiO₂/TiO₂/Cr/TiO₂/SiO₂ multilayer stack etched in a 1:3 aqua regia solution for 16 hours. In addition, a low accelerating voltage (11 kV) electron beam was used in order to obtain surface layer elemental information of the sample. Based on the SEM/EDS analysis, it was clear that the Cr layer was detached and split the symmetric. SiO₂/TiO₂ layers on both sides of the Cr layer. Although not shown, longer reaction times with the aqua regia solution also reduced the adhesion, between the Cr layer and the adjacent TiO2 layer.

In contrast, FIG. 5 provides and SEM image of a SiO₂/TiO₂/Cr/TiO₂/SiO₂ multilayer stack etched in a 1:3 aqua regia solution for 11 hours. As shown in this image, the multilayer stack is intact and EDS analysis did not detect the presence of Al. As such, the Al layer between the glass substrate and the SiO₂/TiO₂/Cr/TiO₂/SiO₂ multilayer stack was etched away and thus afforded a stand-alone and intact flake.

It is appreciated that the method or process taught herein is not limited to the embodiment described above and that any combination of materials, thicknesses, and the like can be used to produce one or more multilayer stacks on the sacrificial layer. For example and for illustrative purposes only, Table 2 below provides a list of refractive index materials that can be used to afford a multilayer stack having desired structural color and/or omnidirectional properties.

TABLE 2

| Refractive Index Materials | | Refractive Index Materials | |
|---|---|---|---|
| (visible region) | | (visible region) | |
| | Refractive | | Refractive |
| Material | Index | Material | Index |
| Germanium (Ge) | 4.0-5.0 | Chromium (Cr) | 3.0 |
| Tellurium (Te) | 4.6 | Tin Sulfide (SnS) | 2.6 |
| Gallium Antimonite (GaSb) | 4.5-5.0 | Low Porous Si | 2.56 |
| Indium Arsenide (InAs) | 4.0 | Chalcogenide glass | 2.6 |
| Silicon (Si) | 3.7 | Cerium Oxide (CeO₂) | 2.53 |
| Indium Phosphate (InP) | 3.5 | Tungsten (W) | 2.5 |
| Gallium Arsenate (GaAs) | 3.53 | Gallium Nitride (GaN) | 2.5 |
| Gallium Phosphate (GaP) | 3.31 | Manganese (Mn) | 2.5 |
| Vanadium (V) | 3 | Niobium Oxide (Nb₂O₃) | 2.4 |
| Arsenic Selenide (As₂Se₃) | 2.8 | Zinc Telluride (ZnTe) | 3.0 |
| CuAlSe₂ | 2.75 | Chalcogenide glass + Ag | 3.0 |
| Zinc Selenide (ZnSe) | 2.5-2.6 | Zinc Sulfate (ZnSe) | 2.5-3.0 |
| Titanium Dioxide (TiO₂) - solgel | 2.36 | Titanium Dioxide (TiO₂) - | 2.43 |
| | | vacuum deposited | |
| Alumina Oxide (Al2O3) | 1.75 | Hafnium Oxide (HfO₂) | 2.0 |
| Yttrium Oxide (Y2O3) | 1.75 | Sodium Aluminum Fluoride | 1.6 |
| | | (Na3AlF6) | |
| Polystyrene | 1.6 | Polyether Sulfone (PES) | 1.55 |
| Magnesium Fluoride (MgF2) | 1.37 | High Porous Si | 1.5 |
| Lead Fluoride (PbF2) | 1.6 | Indium Tin Oxide nanorods | 1.46 |
| | | (ITO) | |
| Potassium Fluoride (KF) | 1.5 | Lithium Fluoride (LiF4) | 1.45 |
| Polyethylene (PE) | 1.5 | Calcium Fluoride | 1.43 |
| Barium Fluoride (BaF2) | 1.5 | Strontium Fluoride (SrF2) | 1.43 |
| Silica (SiO2) | 1.5 | Lithium Fluoride (LiF) | 1.39 |
| PMMA | 1.5 | PKFE | 1.6 |
| Aluminum Arsenate (AlAs) | 1.56 | Sodium Fluoride (NaF) | 1.3 |
| Solgel Silica (SiO2) | 1.47 | Nano-porous Silica (SiO2) | 1.23 |
| N,N′ bis(1naphthyl)-4,4′Diamin | 1.7 | Sputtered Silica (SiO2) | 1.47 |
| (NPB) | | | |
| Polyamide-imide (PEI) | 1.6 | Vacuum Deposited Silica | 1.46 |
| | | (SiO2) | |
| Zinc Sulfide (ZnS) | 2.3 + i(0.015) | Niobium Oxide (Nb₂O₅) | 2.1 |
| Titanium Nitride (TiN) | 1.5 + i(2.0) | Aluminum (Al) | 2.0 + i(15) |
| Chromium (Cr) | 2.5 + i(2.5) | Silicon Nitride (SiN) | 2.1 |
| Niobium Pentoxide (Nb2O5) | 2.4 | Mica | 1.56 |
| Zirconium Oxide (ZrO2) | 2.36 | Polyallomer | 1.492 |
| Hafnium Oxide (HfO2) | 1.9-2.0 | Polybutylene | 1.50 |
| Fluorcarbon (FEP) | 1.34 | Ionomers | 1.51 |
| Polytetrafluro-Ethylene (TFE) | 1.35 | Polyethylene (Low Density) | 1.51 |
| Fluorcarbon (FEP) | 1.34 | Nylons (PA) Type II | 1.52 |
| Polytetrafluro-Ethylene (TFE) | 1.35 | Acrylics Multipolymer | 1.52 |
| Chlorotrifluoro-Ethylene (CTFE) | 1.42 | Polyethylene (Medium Density) | 1.52 |
| Cellulose Propionate | 1.46 | Styrene Butadiene | 1.52-1.55 |
| | | Thermoplastic | |
| Cellulose Acetate Butyrate | 1.46-1.49 | PVC (Rigid) | 1.52-1.55 |
| Cellulose Acetate | 1.46-1.50 | Nylons (Polyamide) Type 6/6 | 1.53 |
| Methylpentene Polymer | 1.485 | Urea Formaldehyde | 1.54-1.58 |
| Acetal Homopolymer | 1.48 | Polyethylene | 1.54 |
| | | (High Density) | |
| Acrylics | 1.49 | Styrene Acrylonitrile | 1.56-1.57 |
| | | Copolymer | |
| Cellulose Nitrate | 1.49-1.51 | Polystyrene (Heat & Chemical) | 1.57-1.60 |
| Ethyl Cellulose | 1.47 | Polystyrene (General Purpose) | 1.59 |
| Polypropylene | 1.49 | Polycarbornate (Unfilled) | 1.586 |
| Polysulfone | 1.633 | | |

The invention is not restricted to the illustrative examples and/or embodiments described above. The examples and/or embodiments are not intended as limitations on the scope of the invention. Methods, processes, apparatus, compositions, and the like described herein are exemplary and not intended as limitations on the scope of the invention. Changes herein and, other uses will occur to those skilled in the art. The scope of the invention is defined by the scope of the claims.

We claim:

1. A process for manufacturing a stand-alone multilayer thin film having three or more layers, the process comprising:
providing a substrate;
depositing a sacrificial layer onto the substrate;
depositing a multilayer thin film onto the sacrificial layer;
exposing the substrate with the sacrificial layer and the thin film to a solution which reacts with the sacrificial layer resulting in the multilayer thin film being removed from the substrate intact.

2. The process of claim 1, wherein the substrate is glass, silicon wafer, or a polymer.

3. The process of claim 2, wherein the solution is an alkaline etchant, acid etchant, or solvent.

4. The process of claim 3, wherein the alkaline etchant is sodium, hydroxide, potassium hydroxide, or ammonium.

5. The process of claim 3, wherein the solvent is selected from the group consisting of acetone, tetrahydrofuran, dimethylformamide, dimethylsulfoxide, toluene, sodium acetate, water, trichlorobenzene, potassium phosphate, chloroform, dimethylacetamide, ortho-dichlorobenzene, methanol, m-cresol, hexafluoro-2-propanol, N-methylpyrrolidone, methylene chloride, chloroform, trifluoroacetic acid, alcohols, and ketones.

6. The process of claim 1, wherein the sacrificial layer is made from metallic and/or semiconductor materials.

7. The process of claim 6, wherein the sacrificial layer is an aluminum layer.

8. The process of claim 1, wherein the sacrificial, layer is a polymer layer.

9. The process of claim wherein the sacrificial layer is deposited using a vacuum deposition technique.

10. The process of claim 1, wherein the sacrificial layer is deposited using a sol-gel technique.

11. The process of claim 1, wherein the sacrificial layer is deposited using a layer-by-layer technique.

12. The process of claim 1, wherein the multilayer thin film is an omnidirectional structural color.

13. The process of claim 1, wherein the multilayer thin film is an omnidirectional infrared reflector.

14. The process of claim 1, wherein the multilayer thin film is an omnidirectional ultraviolet reflector.

15. The process of claim 1 wherein the multilayer thin film is an omnidirectional infrared and ultraviolet reflector.

16. The process of claim 1, wherein the removal of the multilayer thin film from the substrate does not affect the optical and color properties of the multilayer thin film.
